(19) United States
(12) Patent Application Publication
(10) Pub. No.: US 2025/0237433 A1
(43) Pub. Date: Jul. 24, 2025

(54) ELECTRODE MANUFACTURING SYSTEM

(71) Applicants: SK Innovation Co., Ltd., Seoul (KR); SK On Co., Ltd, Seoul (KR)

(72) Inventors: Jang Won SEO, Daejeon (KR); Jun Young LEE, Daejeon (KR); Dae Hee KIM, Daejeon (KR); Ju Hyun KIM, Daejeon (KR)

(21) Appl. No.: 18/929,624

(22) Filed: Oct. 29, 2024

(30) Foreign Application Priority Data
Jan. 22, 2024 (KR) 10-2024-0009671

(51) Int. Cl. F26B 3/30; F26B 3/04; F26B 13/00; H01M 4/04

(52) U.S. Cl. CPC F26B 3/30; F26B 3/04; F26B 13/004; H01M 4/0471

(57) ABSTRACT

An electrode manufacturing system is disclosed. In some implementations, the electrode manufacturing system may include a coating station configured to coat a coating material on a coating substrate traveling along a path, and a drying station configured to dry the coating material. The drying station may include at least one linear infrared lamp configured to irradiate the coating material with infrared light, and opposite ends of the infrared lamp may be disposed to be vertically aligned with opposite edges of the coating material.

### CROSS-REFERENCE TO RELATED APPLICATION(S)

This patent application claims the priority and benefits of Korean Patent Application No. 10-2024-0009671 filed on Jan. 22, 2024, the disclosure of which is incorporated herein by reference in its entirety.

### TECHNICAL FIELD

Embodiments of the present disclosure relate generally to a system for manufacturing an electrode for a secondary battery.

### BACKGROUND

Unlike primary batteries, secondary batteries may be charged and discharged, and thus may be applied to devices within various fields such as digital cameras, mobile phones, notebook computers, hybrid vehicles, and electric vehicles. Recently, among secondary batteries, a large amount of research into lithium secondary batteries, having high energy density and discharge voltages, has been actively conducted.

In general, electrode plates for lithium secondary batteries may be manufactured using a process of coating a positive or negative electrode active material on a substrate to be coated (in the following also referred to as “a coating substrate”), such as an aluminum or copper sheet, and drying the active material.

The coating process and the drying process may have a significant impact on the quality of secondary batteries. However, in the related art, a phenomenon in which an active material of an electrode on which a drying process is performed is partially dried or excessively dried for various reasons may occur. Inconsistent drying may become particularly exacerbated when a production speed of the electrode is increased.

Accordingly, there is a need for an improved device and/or method capable of evenly drying secondary battery electrodes.

### SUMMARY

According to embodiments of the present disclosure, it is possible to provide a secondary battery electrode manufacturing system capable of maintaining even dryness.

A secondary battery manufactured using the electrode manufacturing system according to the present disclosure may be widely applied in the field of green technology, such as electric vehicles, battery charging stations, and other battery-utilizing solar power generation schemes, wind power generation schemes, or the like. In addition, the secondary battery manufactured using the electrode manufacturing system according to the embodiments of the present disclosure may be used in eco-friendly electric vehicles, hybrid vehicles, and the like, to prevent climate change by suppressing air pollution and greenhouse gas emissions.

In some embodiments of the present disclosure, an electrode manufacturing system may include a coating station configured to coat a coating material on a coating substrate traveling along a path, and a drying station configured to dry the coating material. The drying station may include at least one linear infrared lamp configured to irradiate the coating material with infrared light, and opposite ends of the infrared lamp may be disposed to be vertically aligned with opposite edges of the coating material. A linear infrared lamp refers to a lamp that emits infrared radiation in a linear pattern.

A separation distance between the infrared lamp and the coating material may be 5 cm to 10 cm.

The infrared lamp may be disposed to be rotatable along a rotational axis formed in a direction, perpendicular to a direction of a surface of the coating substrate.

The rotational axis may be disposed in a central portion of the infrared lamp in a longitudinal direction.

The infrared lamp may be disposed in a diagonal direction, oblique to a width direction of the coating material, or may be disposed to be parallel to the width direction of the coating material.

The infrared lamp may include a first lamp rotating on a first rotational axis, and a second lamp rotating on a second rotational axis. The first rotational axis and the second rotational axis may be disposed on a straight line, parallel to a width direction of the coating material.

The first rotational axis may be formed at one end of the first lamp, and the second rotational axis may be formed at the other end of the second lamp. The other end of the first lamp and one end of the second lamp may be positioned on the opposite edges of the coating material, respectively.

The first lamp and the second lamp may be disposed in a “V” shape, or may be disposed to form a straight line.

The drying station may further include a hot air supply device configured to supply hot air to the coating material.

The hot air supply device may include a plurality of hot air supply nozzles configured to spray the hot air to the coating material. In the drying station, the plurality of hot air supply nozzles and a plurality of infrared lamps may be alternately disposed in a direction of traveling of the coating material.

In some embodiments of the present disclosure, a manufacturing system for an electrode of a secondary battery may include a coating station configured to apply a coating material on at least one surface of a coating substrate traveling along a path extending over, under, or through the coating station to form a coated substrate and a drying station configured to receive the coated substrate and to dry the coating material of the coated substrate via application of heat and infrared light. The drying station may include two or more linear infrared lamps disposed inside a chamber of the drying station and configured to irradiate the coating material with the infrared light, wherein the two or more infrared lamps may be positioned so that opposite ends of the two or more infrared lamps may be vertically aligned with opposite edges of the coating material, and wherein the coating material may be an active material for the electrode, and the substrate may include a plate of copper or aluminum.

According to an embodiment of the present disclosure, even when traveling speed of a coating substrate to which a coating material is applied is increased, the coating material may be evenly dried, thereby increasing product yield.

### BRIEF DESCRIPTION OF DRAWINGS

Certain aspects, features, and advantages of the embodiments of the present disclosure are illustrated by the following detailed description with reference to the accompanying drawings.

FIG. 1 is a schematic diagram illustrating an electrode manufacturing system according to an embodiment of the present disclosure.

FIG. 2 is a diagram illustrating the drying station of FIG. 1.

FIG. 3 is a cross-sectional view taken along line I-I′ of FIG. 2.

FIG. 4 is a cross-sectional view taken along line II-II′ of FIG. 3.

FIG. 5 is a graph illustrating thicknesses of a coating material according to various types of infrared lamps.

FIG. 6A to 6C are diagrams illustrating each experimental examples of FIG. 3.

FIGS. 7 and 8 are schematic diagrams illustrating an electrode manufacturing system according to another embodiment of the present disclosure.

FIGS. 9 and 10 are schematic diagrams illustrating an electrode manufacturing system according to another embodiment of the present disclosure.

### DETAILED DESCRIPTION

Features of the embodiments of the present disclosure are described by example embodiments with reference to the accompanying drawings. In the present disclosure, the term “coating substrate” means a secondary battery electrode substrate which is subject to the coating process, or which respectively forms the coated substrate, of the electrode manufacturing system. In the present disclosure, the term “vertical alignment” between the opposite ends of the infrared lamp and the opposite edges of the coating material may mean an essential co-alignment, i.e. may mean that when the infrared lamp is projected in a direction, perpendicular to the coating material, the infrared lamp is disposed such that the opposite ends of the projected infrared lamp correspond to the opposite edges of the coating material. Here, the term “substantial” may include a tolerance range, for example the tolerance range may be ±25 mm in a width direction of the coating material.

The embodiments are generally directed to an electrode manufacturing system.

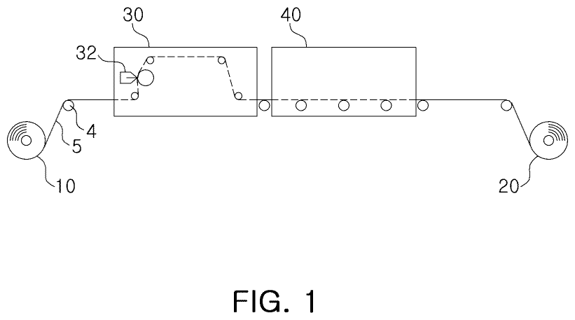

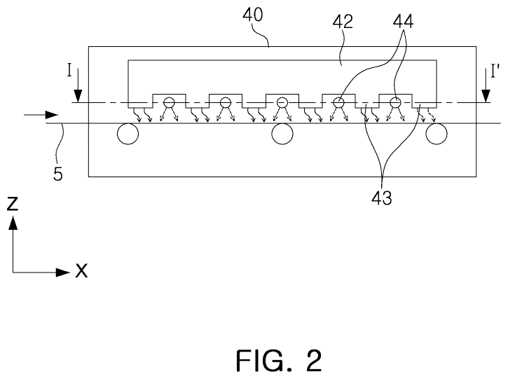

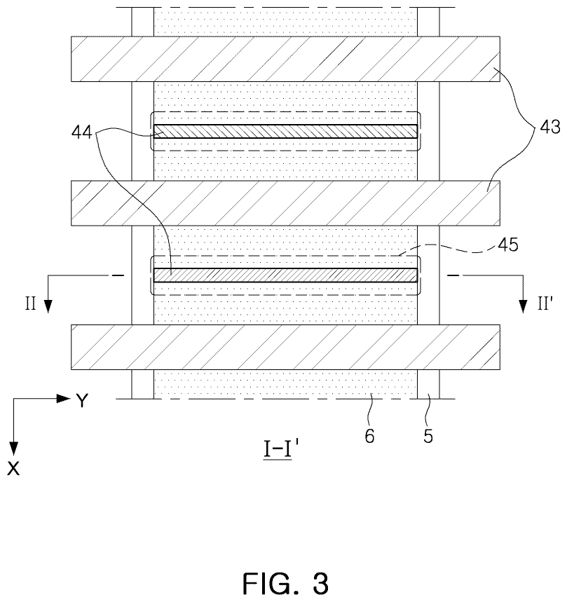

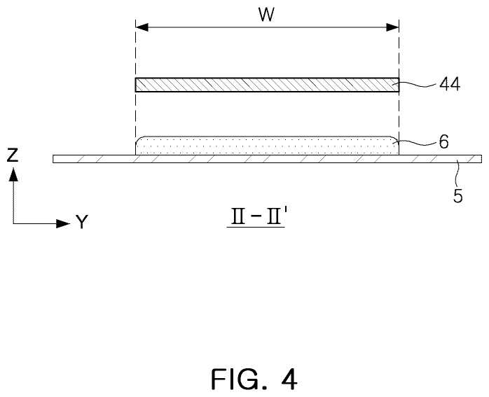

FIG. 1 is a schematic diagram illustrating an electrode manufacturing system according to an embodiment of the present disclosure. FIG. 2 is a diagram illustrating the drying station of FIG. 1. FIG. 3 is a cross-sectional view taken along line I-I′ of FIG. 2. FIG. 4 is a cross-sectional view taken along line II-II′ of FIG. 3.

Referring to FIGS. 1 to 4, a secondary battery electrode manufacturing system according to an embodiment may include an unwinder 10 unwinding and supplying a coating substrate 5, a coating station 30 coating a coating material 6 (see FIG. 4) on a coating region of the coating substrate 5, a drying station 40 drying the coating material 6, and a rewinder 20 rewinding the coating substrate 5.

In the present embodiment, the coating substrate 5 may be provided in the form of a thin strip having a predetermined width, and may refer to a metal thin film for manufacturing an electrode for a secondary battery. For example, the coating substrate 5 may be an aluminum sheet or thin film when a positive electrode is manufactured, and may be a copper sheet or thin film when a negative electrode is manufactured.

The coating substrate 5 may be supplied by the unwinder 10, may travel along a preset path, and may then be rewound by the rewinder 20. In this process, the coating substrate 5 may sequentially pass through the coating station 30 and the drying station 40. To this end, the electrode manufacturing system according to the present embodiment may include a transfer device transferring the coating substrate 5 in the above-described order. For example, the transfer device may include a plurality of rollers 4 rotating while supporting the coating substrate 5.

The unwinder 10 may unwind the coating substrate 5 wound in the form of a roll, and may supply the coating substrate 5 to the coating station 30. As described above, the coating substrate 5, supplied by the unwinder 10, may be a metal sheet or thin film such as an aluminum thin film or a copper thin film.

The coating station 30 may coat the coating material 6 on the coating substrate 5 that is supplied by the unwinder 10 and travelling along a path. To this end, the coating station 30 may have a slot die coater 32, but the embodiments of the present disclosure are not limited thereto.

The coating material 6 may be an active material that is in a slurry state, and a coating process may be performed in the same form for both the positive and negative electrodes. In the present embodiment, a case in which the coating material 6 is coated only on one surface of the coating substrate 5 is described as an example. However, in another embodiment, the coating material 6 may be coated on both opposite surfaces of the coating substrate 5, as may be needed depending on the application.

The drying station 40 may dry the coating material 6 after it has been applied on the coating substrate 5. The drying station 40 may have at least one chamber through which the coating substrate 5 passes. The drying station 40 may remove the moisture from the coating material 6 by applying heat to the coating material 6 as the coating material 6 is passing through the chamber. To this end, the drying station 40 according to the present embodiment may include a first heat source 42 and a second heat source 44.

The first heat source 42 and the second heat source 44 may be different types of heat sources. For example, the first heat source 42 may include a hot air supply device, supplying, to the coating material 6, hot air that is at a preset temperature. In addition, the second heat source 44 may include a heater, applying radiant heat to the coating material 6.

In the drying station 40 according to the present embodiment, heat energy, supplied by the first heat source 42, and heat energy, supplied from the second heat source 44, may be alternately supplied to the coating material 6. As illustrated in FIG. 2, the first heat source 42 may have a plurality of hot air supply nozzles 43 that spray the hot air to the coating material, and the plurality of hot air supply nozzles 43 may be spaced apart from each other at regular intervals. And a plurality of second heat sources 44 may be disposed between the plurality of hot air supply nozzles 43 in a distributed manner.

In the present embodiment, an infrared lamp may be used as the second heat source 44. For example, the second heat source 44 may include at least one linear infrared lamp configured to irradiate the coating material with infrared light. Accordingly, in the drying station 40, the plurality of hot air supply nozzles 43 and a plurality of infrared lamps 44 may be alternately disposed in a direction of travelling of the coating substrate 5, and the coating material 6, coated on the coating substrate 5, may be repeatedly and alternately heated by high-temperature hot air and infrared light to remove a solvent.

As illustrated in FIG. 3, in the present embodiment, the infrared lamp 44 may be disposed between two hot air supply nozzles 43. Accordingly, one irradiation region 45 may be formed between the two hot air supply nozzles 43. For example, the one irradiation region 45 may refer to a region of the coating material 6 in which infrared light, emitted by one or a plurality of infrared lamps 44 positioned between the two hot air supply nozzles 43, is irradiated.

When process speed is increased to increase production speed of an electrode, the coating material 6 may be unevenly dried. When an amount of hot air supplied or an output of the infrared lamp 44 is increased in consideration thereof, cracks may occur in a side surface portion of the coating material 6.

Accordingly, to eliminate these issues, a linear infrared lamp 44 was modified, into various shapes, and a state in which the coating material 6 is dried was confirmed.

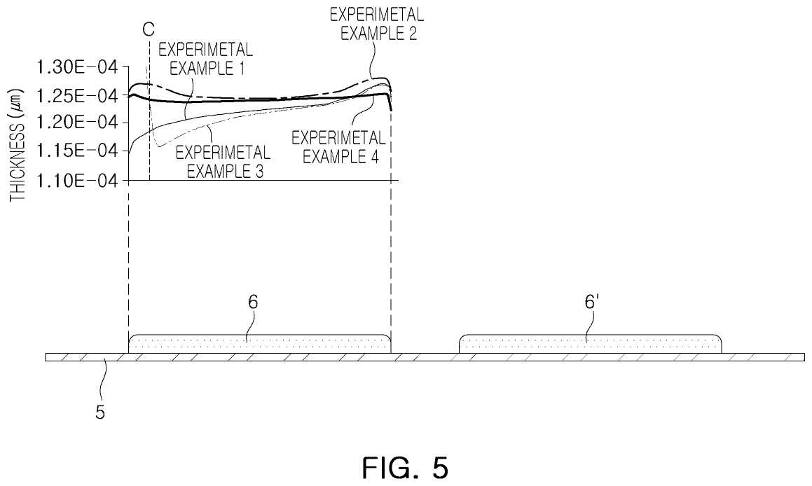

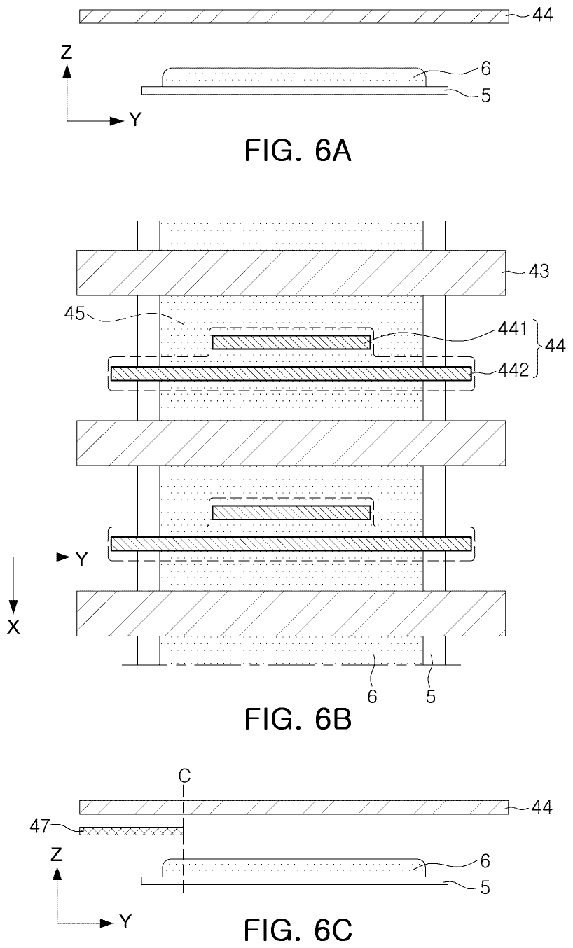

FIG. 5 is a graph illustrating thicknesses of a coating material according to various types of infrared lamps, and FIG. 6A to 6C are diagrams illustrating each experimental example of FIG. 3.

Here, FIG. 5 illustrates, in a process of forming an electrode by applying the coating materials 6 and 6′ on two regions of one coating substrate 5, a variation in thickness of the coating material 6 obtained by performing measurement on a cross-section of the coating material 6 coated on a left region, among coating materials 6 and 6′ coated on the two regions of the one coating substrate 5. In addition, FIGS. 6A and 6C illustrate cross-sections corresponding to II-II′ of FIG. 3, and FIG. 6B illustrates a cross-section corresponding to I-I′ of FIG. 2.

Referring to FIGS. 5 to 6C together, in Experimental Example 1 for comparison, as illustrated in FIG. 6A, a length of the infrared lamp 44 may be formed to be longer than a width of the coating substrate 5. Accordingly, the infrared lamp 44 may be disposed such that at least a portion of the infrared lamp 44 extends toward the outside of the coating substrate 5.

Referring to the graph of Experimental Example 1, it can be seen that the coating material 6 had a gradually increasing thickness toward a right side of the coating material 6. From such a result, it can be inferred that the coating material 6 of Experimental Example 1 had a high dryness at a left edge thereof and a low dryness at a right edge thereof.

Such a result may be due to a larger amount of heat being applied to the left edge of the coating material 6 as the infrared lamp 44 was disposed up to the outside of the coating substrate 5. It can be seen that a corresponding portion was overdried.

In Experimental Example 2 for comparison, as illustrated in FIG. 6B, two infrared lamps 441 and 442 having different lengths were used to irradiate one irradiation region 45. A longer lamp 442 was formed to be similar to the infrared lamp 44 applied in Experimental Example 1, and a shorter lamp 441 was formed to have a length shorter than a width of the coating material 6, such that the entire shorter lamp 441 was disposed in a central portion of the coating material 6 to oppose the coating material 6. In addition, as the two infrared lamps 441 and 442 were used, outputs of the long lamp 442 and the short lamp 441 were lowered, as compared to Experimental Example 1.

Referring to the graph of Experimental Example 2, it can be seen that a thickness variation of the coating material 6 was reduced, as compared to Experimental Example 1. However, it can be seen that a thickness of a central portion of the coating material 6 was reduced as compared to an edge portion of the coating material 6, adjacent to the coating substrate 5. That is, it can be seen that Experimental Example 2 had a reduced thickness variation as compared to Experimental Example 1 due to a second lamp 44 additionally disposed on the central portion of the coating material 6, but a thickness variation between the central portion and opposite edge portions, adjacent to the coating substrate 5, occurred.

Accordingly, in the Experimental Example 2, it was determined that the thin central portion was overdried or the thick edge portion was under-dried.

In Experimental Example 3 for comparison, as illustrated in FIG. 6C, in addition to the configuration of Experimental Example 1, a shielding plate 47 was disposed along an edge of the coating material 6, that is, a boundary between the coating material 6 and the coating substrate 5. A dotted line C of FIG. 5 may refer to a right boundary C of the shield plate 47 of FIG. 6C. The shielding plate 47 was disposed between the infrared lamp 44 and the coating substrate 5, and at least a portion of the shielding plate 47 was disposed to oppose the coating material 6.

In Experimental Example 3, the shielding plate 47 was applied to compensate for over drying of a specific region in Experimental Example 1. An overall graph shape of Experimental Example 3 may be similar to that of Experimental Example 1. However, it can be seen that a portion of the coating material 6, opposing the shielding plate 47, had a rapidly increasing thickness. That is, it can be confirmed that heat from the infrared lamp 44 was excessively blocked by the shielding plate 47 and the heat was not properly transmitted to a left edge of the coating material 6.

In Experimental Example 4 which is in accordance with the present invention, as illustrated in FIGS. 3 and 4, the length of the infrared lamp 44 was formed to be the same as the width W of the coating material 6. Specifically, in Experimental Example 4, the infrared lamp 44 was disposed such that opposite ends of the infrared lamp 44 were vertically aligned with opposite edges of the coating material 6. Here, vertical alignment may mean that when the infrared lamp 44 is projected in a direction, perpendicular to the coating material 6, the infrared lamp 44 is disposed such that the opposite ends of the projected infrared lamp 44 correspond to the opposite edges of the coating material 6. That is, it can be understood that the opposite ends of the infrared lamp 44 were disposed to be in contact with vertical lines formed by the opposite edges of the coating material 6. Referring to the graph of Experimental Example 4, it can be seen that the coating material 6 had a small thickness variation and an overall similar thickness. Accordingly, it can be seen that the coating material 6 was most evenly dried when the infrared lamp 44 was disposed such that the opposite ends of the infrared lamp 44 corresponded to the opposite edges of the coating material 6.

In Experimental Example 4, an irradiation region 45 was formed as illustrated in FIG. 3, such that a relatively small amount of infrared light was irradiated to the opposite edge portions of the coating material 6. Accordingly, an even amount of irradiated infrared light was not irradiated (or did not reach) to the coating material 6. However, as confirmed through the above-described experimental examples, in a drying method using the infrared lamp 44, the edge portions of the coating material 6 tend to be dried more than the central portion. Accordingly, it can be understood that the overall coating material 6 was evenly dried when a relatively small amount of infrared light was applied to the edge of the coating material 6.

Accordingly, in an electrode manufacturing system according to the present embodiment, the infrared lamp 44, a second heat source, may be formed as a linear lamp 44, and the opposite ends of the infrared lamp 44 may be disposed to correspond to the opposite edges of the coating material 6, considering the above-described Experimental Example 4 as an optimal drying condition.

Even when drying is performed under the same condition, a state in which the coating material 6 is dried may be changed depending on an output of the infrared lamp 44 and an amount of heat energy transmitted to the coating material 6. Accordingly, the output of the infrared lamp 44 or a distance between the infrared lamp 44 and the coating material 6 may be properly changed depending on a composition, thickness, traveling speed, or the like of the coating material 6.

However, as the infrared lamp 44 is farther from the coating material 6, infrared light irradiated by the infrared lamp 44 may be diffused. Thus, when the infrared lamp 44 is disposed to be excessively far apart from the coating material 6, the irradiation region 45 may be excessively expanded. For example, even when the infrared lamp 44 is disposed as in Experimental Example 4, the irradiation region 45 may be formed to be similar to that in Experimental Example 1 when the infrared lamp 44 is disposed to be excessively far apart from the coating material 6. In addition, when the infrared lamp 44 is excessively close to the coating material 6, the irradiation region 45 of the infrared light may become narrow, such that drying may not be efficiently performed.

In consideration thereof, in the present disclosure and in the present embodiment, a separation distance between the infrared lamp 44 and the coating material 6 may be formed within a range of 5 cm to 10 cm. However, the present embodiment is not limited thereto, and the separation distance may be adjusted such that the irradiation range is not beyond the coating substrate 5.

In addition, in general, a region of the infrared lamp 44, substantially emitting infrared light, may be smaller than an entire region of the infrared lamp 44. For example, at least one of the opposite ends of the infrared lamp 44 may have a connection connector. In this case, a portion of the infrared lamp 44, substantially emitting infrared light, may start in a position spaced a predetermined distance apart from the connection connector of the infrared lamp 44. Accordingly, in the present embodiment, the opposite ends of the infrared lamp 44 may refer to opposite ends of the region of the infrared lamp 44, substantially emitting infrared light.

In addition, in the present disclosure and in the present embodiment, vertical alignment between the opposite ends of the infrared lamp 44 and the opposite edges of the coating material 6 may include a tolerance range. For example, the tolerance range may be ±25 mm in a width direction of the coating material 6.

The electrode manufacturing system according to the present embodiment, configured as described above, may evenly dry the coating material 6 even when travelling speed of the coating substrate 5 to which the coating material 6 is applied is increased, thereby increasing product yield.

Hereinafter, embodiments of the present disclosure will be further described with reference to specific experimental examples. Examples and comparative examples included in the experimental examples are merely illustrative of the present disclosure and do not limit the scope of the appended patent claims. It will be apparent to those skilled in the art that various changes and modifications could be made to the examples within the scope and spirit of the disclosed technology, and are also within the scope of the appended claims.

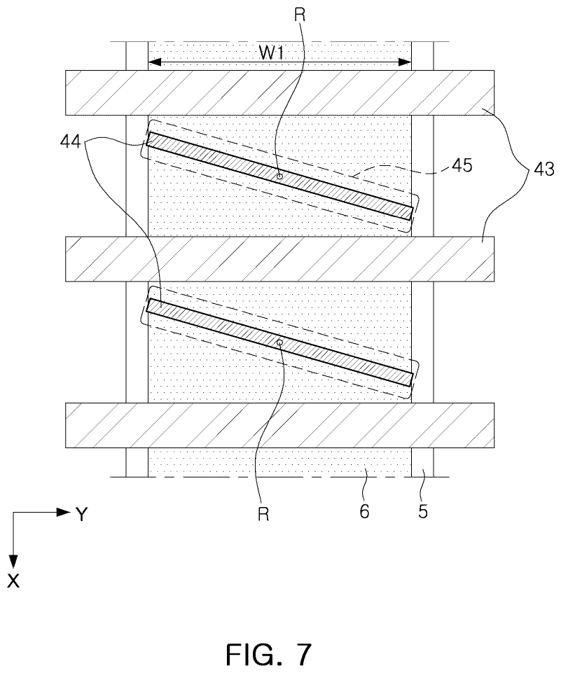

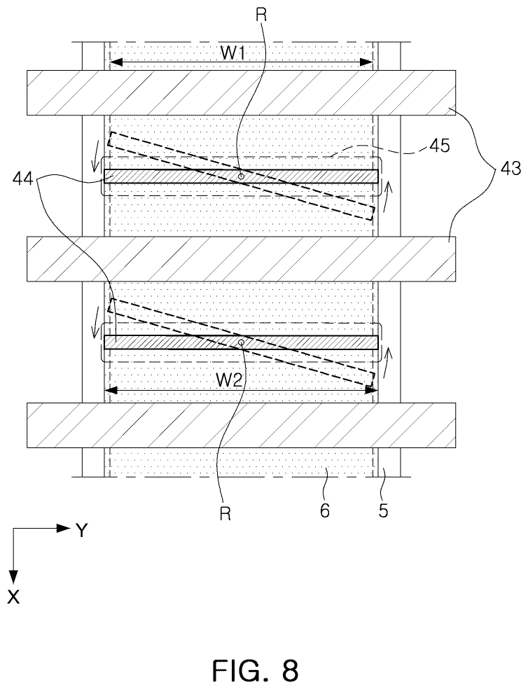

FIGS. 7 and 8 are schematic diagrams illustrating an electrode manufacturing system according to another embodiment of the present disclosure, and illustrate a cross-section corresponding to that of FIG. 3.

Referring to FIGS. 7 and 8, an infrared lamp 44 according to the present embodiment may be rotatably disposed on an upper portion of a coating material 6.

Specifically, a rotational axis R may be formed on a central portion of each infrared lamp 44 in a longitudinal direction, and the infrared lamp 44 may be rotated along the rotational axis R. The rotational axis R may be disposed in a direction, perpendicular to a direction of a surface (for example, an X-Y plane) of a coating substrate 5. The infrared lamp 44 may be rotated through various known rotational driving devices, such as motors.

As the infrared lamp 44 is rotatably disposed, the infrared lamp 44 according to the present embodiment may be disposed in a diagonal direction, oblique to a width direction (for example, a Y-direction) of the coating material 6, as illustrated in FIG. 7, or may be disposed to be parallel to the width direction of the coating material 6, as illustrated in FIG. 8.

The infrared lamp 44 according to the present embodiment may be rotated to correspond to a width of the coating material 6. For example, as illustrated in FIG. 7, when the width of the coating material 6 is W1, the infrared lamp 44 may be disposed in the diagonal direction, oblique to the width direction of the coating material 6, to correspond to the width of the coating material 6. Accordingly, opposite ends of the infrared lamp 44 may be disposed to correspond to opposite edges of the coating material 6.

In addition, as illustrated in FIG. 8, when the width of the coating material 6 is W2, the infrared lamp 44 may be rotated, and accordingly the opposite ends of the infrared lamp 44 may be disposed to correspond to the opposite edges of the coating material 6.

The electrode manufacturing system according to the embodiment described above, may perform drying using the same infrared lamp 44 even when the width of the coating material 6 is changed, such that electrodes having various sizes may be manufactured using one electrode manufacturing system.

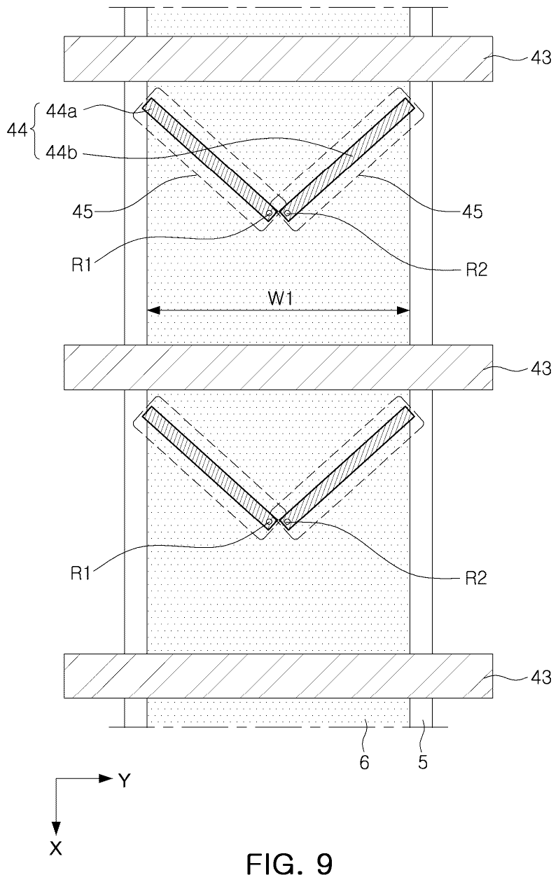

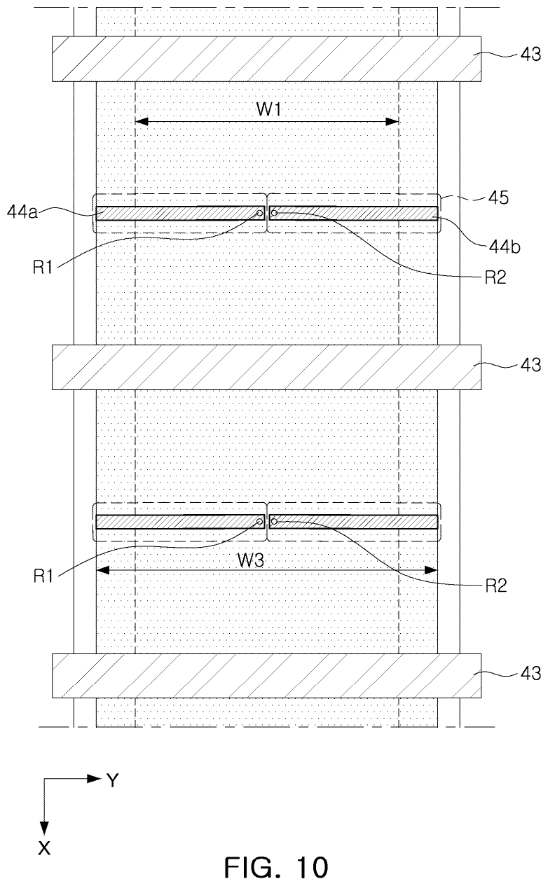

FIGS. 9 and 10 are schematic diagrams illustrating an electrode manufacturing system according to another embodiment of the present disclosure.

Referring to FIGS. 9 and 10, in the electrode manufacturing system, a plurality of infrared lamps 44a and 44b may form one irradiation region 45. In addition, two infrared lamps 44a and 44b may be rotatably disposed, respectively.

Specifically, the infrared lamps 44a and 44b, irradiating the irradiation region 45, may include a first lamp 44a and a second lamp 44b, and the first lamp 44a and the second lamp 44b may be rotated along different rotation axes R1 and R2, respectively. A first rotational axis R1, a rotational axis of the first lamp 44a, may be positioned at one end of the first lamp 44a. A second rotational axis R2, a rotational the second lamp 44b, may be positioned at one end of the second lamp 44b. For example, the first rotational axis R1 and the second rotational axis R2 may each be formed at an end disposed on the inside of the coating material 6, among opposite ends of the lamps 44a and 44b, respectively. Accordingly, the first rotational axis R1 and the second rotational axis R2 may be disposed to be adjacent to each other, and may be disposed on a straight line, parallel to a width direction of the coating material 6.

In a similar manner to the above-described embodiment, each of the rotation axes R1 and R2 may be disposed in a direction, perpendicular to a direction of a surface (for example, an X-Y plane) of a coating substrate 5, and the first lamp 44a and the second lamp 44a may be rotated through various known rotational driving devices, such as motors.

The first lamp 44a and the second lamp 44b according to some embodiments may be disposed in a “V” shape, as illustrated in FIG. 9, or may be disposed to form a straight line parallel to the width direction of the coating material 6, as illustrated in FIG. 10.

In a similar manner to the above-described embodiments, the infrared lamp 44 may also be rotated to correspond to a width of the coating material 6. For example, as illustrated in FIG. 9, when the width of the coating material 6 is W1, the infrared lamp 44 may be disposed in a “V” shape to correspond to a width of the coating substrate 5, and the other end of the first lamp 44a and one end of the second lamp 44b may be positioned on the opposite edges of the coating material 6. Here, W1 may be shorter than a total length of the first lamp 44a and the second lamp 44b.

In addition, as illustrated in FIG. 10, when the width of the coating material 6 is W3, the first lamp 44a and the second lamp 44b may be rotated to be disposed on a straight line, parallel to the width direction of the coating material 6. Accordingly, opposite ends of the infrared lamp 44 may be disposed to correspond to opposite edges of the coating material 6 having a width W3.

As such, the electrode manufacturing system according to the present embodiment may manufacture an electrode by disposing the infrared lamps 44 in various shapes depending on the width of the coating material 6.

The features described above are merely examples of the application of the principles of the embodiments of the present disclosure, and other components may be included without departing from the scope of the disclosed technology.

For example, in the above-described embodiments, a case in which a coating material is coated only on one surface of a coating substrate is described as an example. However, the embodiments are not limited thereto, and opposite surfaces of the coating substrate may be coated with the coating material. In this case, a first heat source and a second heat source may be disposed on the opposite surfaces of the coating substrate.

Only specific examples of implementations of certain embodiments are described. Variations, improvements and enhancements of the disclosed embodiments and other embodiments may be made based on the present disclosure. Furthermore, the embodiments may be combined to form additional embodiments.

What is claimed is:

1. An electrode manufacturing system comprising:
a coating station configured to apply a coating material on a coating substrate traveling along a path; and
a drying station configured to dry the coating material;
wherein the drying station includes at least one linear infrared lamp configured to irradiate the coating material with infrared light, and
opposite ends of the infrared lamp are disposed to be vertically aligned with opposite edges of the coating material.

2. The electrode manufacturing system of claim 1, wherein a separation distance between the infrared lamp and the coating material is 5 cm to 10 cm.

3. The electrode manufacturing system of claim 1, wherein the infrared lamp is disposed to be rotatable along a rotational axis formed in a direction perpendicular to a direction of a surface of the coating substrate.

4. The electrode manufacturing system of claim 3, wherein the rotational axis is disposed in a central portion of the infrared lamp in a longitudinal direction.

5. The electrode manufacturing system of claim 4, wherein the infrared lamp is disposed in a diagonal direction, oblique to a width direction of the coating material, or is disposed to be parallel to the width direction of the coating material.

6. The electrode manufacturing system of claim 3, wherein
the infrared lamp includes:
a first lamp rotating on a first rotational axis; and
a second lamp rotating on a second rotational axis,
the first rotational axis and the second rotational axis are disposed on a straight line, parallel to a width direction of the coating material.

7. The electrode manufacturing system of claim 6, wherein
the first rotational axis is formed at one end of the first lamp, and the second rotational axis is formed at the other end of the second lamp, and
the other end of the first lamp and one end of the second lamp are positioned on the opposite edges of the coating material, respectively.

8. The electrode manufacturing system of claim 6, wherein the first lamp and the second lamp are disposed in a “V” shape or are disposed to form a straight line.

9. The electrode manufacturing system of claim 1, wherein the drying station further includes a hot air supply device configured to supply hot air to the coating material.

10. The electrode manufacturing system of claim 9, wherein
the hot air supply device includes a plurality of hot air supply nozzles configured to spray the hot air to the coating material, and
in the drying station, the plurality of hot air supply nozzles and a plurality of infrared lamps are alternately disposed in a direction of traveling of the coating material.

11. A manufacturing system for an electrode of a secondary battery, the manufacturing system comprising:
a coating station configured to apply a coating material on at least one surface of a coating substrate traveling along a path extending over, under, or through the coating station to form a coated substrate; and
a drying station configured to receive the coated substrate and to dry the coating material of the coated substrate via application of heat and infrared light;
wherein the drying station includes two or more linear infrared lamps disposed inside a chamber of the drying station and configured to irradiate the coating material with the infrared light,
wherein the two or more infrared lamps are positioned so that opposite ends of the two or more infrared lamps are vertically aligned with opposite edges of the coating material; and
wherein the coating material is an active material for the electrode, and the substrate includes a plate of copper or aluminum.
